(19) United States
(12) Patent Application Publication
(10) Pub. No.: US 2016/0298054 A1
(43) Pub. Date: Oct. 13, 2016

(54) METHOD FOR PRODUCING RESINOUS FATTY ACID SOAP, FATTY ACID SOAP COMPOSITION AND USE THEREOF

(71) Applicant: FORCHEM OY, Rauma (FI)

(72) Inventors: Mikko RINTOLA, Rauma (FI); Juha ORTE, Rauma (FI)

(73) Assignee: Forchem Oy, Rauma (FI)

(21) Appl. No.: 15/036,716

(22) PCT Filed: Nov. 17, 2014
(86) PCT No.: PCT/FI2014/050866

§ 371 Date: May 13, 2016

(30) Foreign Application Priority Data
Nov. 15, 2013 (FI) 20136135

(51) Int. Cl. C11C 1/02; C11D 13/02; A01N 65/40; A01N 65/00; A01N 63/00; A01N 65/08; C11D 13/26; C11D 9/26

(52) U.S. Cl. CPC C11C 1/025; C11D 13/26; C11D 13/02; C11D 9/26; A01N 65/00; A01N 63/00; A01N 65/08; A01N 65/40

(57) ABSTRACT

The present invention relates to a method for manufacturing soap from fatty and resin acids, in particular from tall oil fatty acid comprising resin acids. The method is based on a process in which the water conventionally utilized for saponification is partially replaced with a solvent that decreases the viscosity of the reaction mixture and results in a high dry matter content of the reaction product. An object of the invention is also a composition comprising fatty and resin acid soap and its use as a disinfectant or antiseptic agent.

### FIELD OF THE INVENTION

The present invention relates to fatty acid compositions and their manufacture. In particular, the invention relates to a method for the saponification of a resinous fatty acid to an alkali salt of resin acid and fatty acid. The invention relates also to new fatty acid products and their use.

### DESCRIPTION OF RELATED ART

In general, resin acids refer to water-insoluble amorphous, solid or liquid plant secretions. Regarding their chemical structure, they are long-chain organic carbon compounds having a backbone structure based on three rings, each formed by six carbon atoms. As well known, resin acids possess antimicrobial/antibacterial properties, which is the reason why they are frequently used for the production of various disinfectant soaps and compositions. For example, the Finnish patent application FI 20120287 discloses an antimicrobial aqueous mixture composition consisting of certain resin acids (such as dehydroabietic acid) and applicable as a medicinal or conditioning agent or additive in various technical products (such as cleaning agents).

Fatty acids are fatty acid esters of plant or animal origin and long-chain monocarboxylic acids formed from hydrocarbons derived from these, possessing the general formula R—COON, in which R is an aliphatic hydrocarbon chain. Based on the presence or absence of double bonds, fatty acids are traditionally classified into unsaturated, saturated and polyunsaturated fatty acids.

Fatty acids are commonly isolated from fatty acid ester sources, such as e.g. vegetable oil triglycerides, by hydrolysis. Fatty acid soap has been traditionally manufactured by mixing together fatty acid, water and an alkaline hydroxide. The method is problematic, for example due to rapidly increasing viscosity, whereby it is difficult or almost impossible upon processing of the product to achieve higher dry matter concentrations allowing transfer in liquid (pumpable) form. On the other hand, low dry matter content results in a low processing capacity and thus raises the energy costs of the process upon further refining of the product, for instance by drying it into the dry matter form.

The increase in viscosity can to some extent be controlled by changing the metal hydroxide utilized for saponification and by elevating the processing temperature. For instance, exchanging sodium for potassium is known to decrease viscosity both in processing and in the obtained soap product. The adjustment of viscosity in the process by known techniques is, however, very limited, and high dry matter contents are not achieved.

U.S. Pat. No. 2,558,543 discloses a partial saponification of crude tall oil, in which according to example 3, 100 parts of crude tall oil was mixed into a solution containing 6.1 parts of NaOH, which had been dissolved in 45 parts of water and 5 parts of isopropanol, whereby partial saponification of the tall oil solution was achieved. The mixture thus obtained was fed into countercurrent extraction, in which the resin acid was extracted into gasoline.

U.S. Pat. No. 3,804,819 discloses the recovery of fatty acids from tall oil distillation heads, where the fatty acids contained in the heads are saponified with an aqueous base to form a fatty acid soap into the aqueous stage. In the saponification, a wetting component (wetting agent) such as a lower alcohol is utilized, amounting to 10 to 40 weight-% of the saponification reaction mixture. Described in example 1 is a mixture, in which 20 weight-% of the tall oil distillation heads are mixed with 60 parts by weight of water, 20 parts by weight of isopropanol and 3.7 parts by weight of sodium hydroxide.

Disclosed in the JP Patent 55725400 is the manufacture of liquid soap, in which a mixture of tall oil fatty acids and resin acids is saponified with soybean oil and coconut oil. A KOH solution and a polar solvent (1 to 10 m-%) are utilized for the saponification. However, the publication does not describe an energy-efficient process, by which a low-viscosity fatty acid soap comprising a high dry matter content is achieved.

Fatty acid compositions obtainable by known art possess low solid matter content; the dry matter content of fatty acid soap normally remains below approximately 24 weight percent at the maximum. For this reason the production, transportation and eventual concentration is expensive and time-consuming. Significant savings are achieved for example by carrying out the technical implementation of the product and method of the Finnish patent application FI 20125509 according to the present invention.

### SUMMARY OF THE INVENTION

The present invention is based on the idea that a fatty acid comprising resin acids is dissolved in a solvent- and water-containing alkaline reagent solution. A polar solvent is chosen as the solvent.

Examples of suitable solvents include primary C₁-C₄ alcohols and secondary alcohols such as isopropanol or acetone and their mixtures. Saponification can be performed by using any known alkaline hydroxide.

A sufficient amount of water enabling the saponification of all resin and fatty acids should be used or formed in the process. Water is most preferably used in such an amount that esterification of fatty acids cannot take place.

The reaction mixture can be recovered as such, after adjustment of pH, or after purification such as bleaching treatment, or can be dried.

By applying the invention a low-viscosity composition comprising fatty and resin acid soap is obtained having high dry matter content, generally over 30 weight-%, in particular about 40 to 70 weight-%. The composition comprises a polar solvent. The solvent content is about 10 to 50% of the total weight of the composition.

More specifically, the method according to the present invention is characterized by what is stated in the characterizing part of claim 1.

The composition comprising fatty and resin acid soap is in turn characterized by what is stated in claim 19.

The use according to the invention is characterized as stated in claim 25.

Significant benefits are achieved with the invention. Accordingly, the present solution provides a process in which the manufacture of soap from fatty acid, such as tall oil fatty acid, is made substantially easier. By using the method according to the invention a processable fatty acid soap having a dry matter content of up to 60 percent by weight can be achieved by replacing the traditionally used water at least partially with a solvent.

One of the advantages of the present invention is also the low viscosity of the composition, whereby technical processibility, production costs and reactivity of saponification is better compared with normal saponification carried out in water. The solvent, such as an alcohol, does not participate in the reaction, but instead functions solely as a dissolving component, whereby it can be either totally or partially removed after saponification. Recycling of the solvent in the process is also possible.

Due to the lowered viscosity, an up to threefold dry matter content is achieved in the reaction. Accordingly, the capacity of the processing equipment both in the reaction and the optional drying stage increases, or the size of the equipment to be invested can correspondingly be decreased. In addition, the amount of energy used for the process decreases.

The composition of the invention comprising fatty and resin acid soap can be used as a generally disinfective or antiseptic agent for the inhibition of growth, extermination or inactivation of disease-causing microorganisms. Disclosed in certain Finnish patent applications, FI 20125509 and FI 20136113, is a particular application, for which significant benefit is achieved in the technical implementations of at least one embodiment in the production of fatty and resin acid soap as described in the present invention.

As stated above, it is known in the art to use water/alcohol mixtures together with lye for the saponification of tall oil. The high fatty and resin acid salts content (dry matter content) characteristic of the present invention is, however, achieved with a considerably smaller amount of water and higher amount of alcohol, respectively, than what is disclosed in the known art.

Next, the present technology will be described more closely with the aid of the appended drawings.

### BRIEF DESCRIPTION OF THE DRAWINGS

Shown in FIG. 1 is a diagram indicating the change in viscosity of a sodium salt of a resin-containing fatty acid (soap) produced by a conventional method involving a high water content at different temperatures and dry matter contents of 16 to 28%. Shown in FIG. 2 is a diagram indicating how the viscosity of a sodium salt of a resin-containing fatty acid produced by the solvent method of the present invention changes at different temperatures and dry matter contents of 50 to 70%.

FIGS. 3a and 3b show diagrams depicting the viscosity and solvent content of a fatty acid sodium salt at dry matter contents of 50 to 70%. The viscosities have been measured at a processing temperature of 70° C., using 2-propanol (FIG. 3a) and ethanol (FIG. 3b), respectively, as solvent.

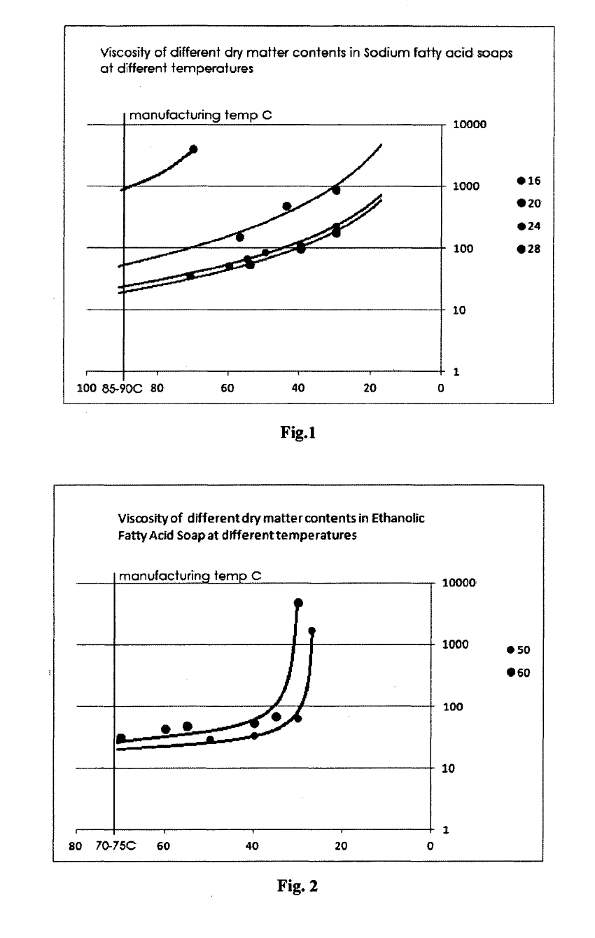

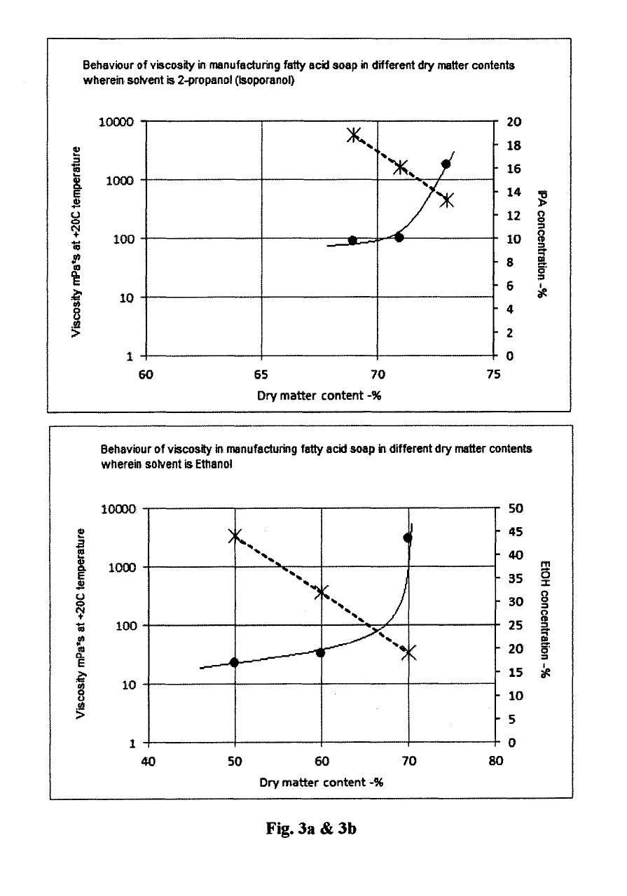

### PREFERRED EMBODIMENTS

In the method according to the present invention a resinous fatty acid soap is manufactured by mixing together a resin acid and a fatty acid, water, a solvent and an alkaline hydroxide. In the method the solvent used to partially replace the water strongly decreases the viscosity of the mixture during processing, whereby substantially larger increase in the amount of fatty acid is possible as compared with the conventional way of processing.

In addition to the high dry matter content, the partial replacement of water with solvent decreases the need of energy utilized in the optional drying process. Since the solvent does not participate in the actual reaction in the saponification reaction, it is essentially not consumed and can also be efficiently recycled despite the generated azeotropic mixtures. The solvent and the water can also be removed after the reaction either completely or partially.

In a method of the invention the soap is manufactured from fatty and resin acids, according to which method a composition comprising fatty and resin acids is saponified with alkali. In the method an alkaline solution comprising water, a polar solvent and a base is first prepared and then subjected to high-shear forces, i.e. the fatty acid composition is added under vigorous stirring in order to dissolve the acids contained therein into the alkaline solution. The water content of the alkaline solution is kept high enough to prevent the formation of fatty acid esters and to saponify the fatty and resin acids. Saponification is continued until a significant proportion of the fatty acids have been saponified. Specifically this means that saponification is continued until at least 50 weight-%, preferably over 80 weight-% and most preferably over 95 weight-% of the resin acids and fatty acids have been saponified.

According to one preferred embodiment, saponification is continued until a composition is achieved having a dry matter content of 40 to 75 weight-%, most preferably 50 to 60 weight-%, the salt of the resin acid and fatty acid constituting at least 80 weight-%, more preferably at least 90 weight-% and in particular about 92 to 99 weight-% of the dry matter of the composition.

After the optional drying process, the dried product composition has a high dry matter content, even 95 to 100 weight-%, in particular almost 100 weight-% and a correspondingly low solvent and water content of 0 to 5 weight-%, in particular almost 0 weight-%.

Any biocompatible polar solvent such as an aliphatic or aromatic alcohol can be utilized to form the alkaline solution.

According to one embodiment the solvent is an aliphatic lower alcohol, for example a C₁-C₄ alcohol, especially methanol, ethanol or propanol.

In another embodiment the solvent is an aliphatic lower ketone, such as acetone.

As the alkali for forming the alkaline solution for example a hydroxide is used, such as an alkali metal hydroxide, e.g. NaOH, KOH, a metal hydride such as an alkali metal hydride, e.g. Nall, or metal alkoxides, ethylate or methylate, such as CH₃ONa, or mixtures thereof

It should be noted that changing the metal hydroxide in the method affects the viscosity of the product in a manner analogous to the conventional method. Furthermore, the composition of the solvent has a major influence on the viscosity of the reaction product. For instance, replacing sodium hydroxide with potassium hydroxide and replacing ethanol with isopropanol increases the solubility of the formed salts in the mixture.

According to one embodiment the dynamic viscosity of the mixture formed from the alkaline solution and the fatty acid composition comprising resin acids during saponification is not more than 1000 mPa·s, in particular not more than 600 mPa·s, most suitably not more than 200 mPa·s.

In the conventional saponification method prepared into the water phase typically comprising 70 to 80% of water, fatty acid product is slowly added into a metal hydroxide solution prewarmed to 60 to 70° C. If drying of the reaction product is desired, this thus requires the evaporation of a large volume of water, which is not reasonable in the sense of energy economy. According to a calculated example, a mixture of 1000 kg containing 800 kg of water requires almost 2160 MJ (600 kWh) of energy.

Saponification processes are exothermic thus they produce heat. In the solvent method of the present invention, addition of the fatty acid mixture comprising resin acids causes agglomeration of the soap, whereby soap molecules precipitate in the mixture and the temperature of the mixture will simultaneously increase. After the fatty acid has been added, the viscosity of the mixture decreases and the agglomerates dissolve in water forming, depending on the dry matter content of the solution, a fluid or gel-like liquid. In fact, a preferred embodiment involves preparing the product by adding the solvent-water-metal hydroxide mixture to a cool, e.g. 30 to 40° C. fatty acid, whereby the mixture spontaneously warms up to a temperature of approx. 60 to 70° C. Furthermore, the optionally conducted evaporation process involving the evaporation of only a small amount of water and solvent consumes respectively less energy than the conventional method. According to a calculated example, a mixture of 1000 kg containing 300 kg of ethanol and 100 kg of water consumes less than 1080 MJ (300 kWh) of energy.

There is no limitation to the chemical form of the fatty acid or its fatty acid composition or degree of saturation, whereby the fatty acid can be manufactured from any source, such as e.g. from tall oil, rapeseed oil, palm oil or olive oil, or from an animal source, e.g. fish oil or beef tallow, or from intermediate or residual products obtained from processing of the above-mentioned sources, e.g. fatty acid distillate generated in connection with refining processes, and have these refined to any degree of purity and processed by any method before utilizing in the saponification process. The fatty acid can also be a mixture of conventional plant fatty acids or a mixture of fatty acids of wood or animal origin. Fatty acid can also be produced by saponifying directly from glycerides (mono-, di-, tri-) or from a mixture thereof with resin acid or from a mixture of free fatty acid and the above-mentioned glycerides, wherein glycerol or a glycerol ester is present as one of the components.

While the present invention is not limited to the origin of the fatty acid, according to a preferable embodiment use is made of tall oil fatty acid, which naturally comprises resin acids. The composition of the fatty acid product comprises 0.5 to 95 weight-%, in particular about 1 to 50 weight-% of saponified or partially free resin acids.

By applying the invention a composition comprising fatty and resin acid soap can be obtained having a dry matter content of 40 to 70 weight-%, in particular 60 to 70 weight-%, and containing about 10 to 50%, in particular 10 to 20 weight-% of a polar, preferably anhydrous solvent based on the total weight of the composition.

In one embodiment the composition is dried to a dry matter content of 95 to 100 weight-%.

Handling and transportation of compositions having a high dry matter content is quite inexpensive, without the need of lowering their water contents e.g. by evaporating in the application.

The composition of the invention comprising fatty and resin acid soap has numerous applications. The soap product is environmentally friendly and it can be modified by choosing the appropriate solvent and process conditions according to the application. The soap can, for example, be generally used as a disinfectant or antiseptic agent against micro-organisms and bacteria. According to an embodiment it is possible by using the fatty acid soap comprising resin acid to regulate the quantity of microbial population in the digestive tract of animals, by modifying soap properties to be suitable for addition into animal feed.

In the following, the present technology is described with the aid of few non-limiting examples. A skilled person should, however, understand that both the embodiments described in the description and the accompanying examples are only meant to illustrate the invention and its reproducibility. Alterations and variations are possible within the scope of the clams.

### EXAMPLES

### Example 1

### Conventional Manufacture of Na-Soap

100 g of fatty acid having a resin acid content of 8 weight-% was warmed to a temperature of 60° C. To the vigorously stirred prewarmed fatty acid was added slowly 472.3 g of aqueous NaOH solution (14.3 g NaOH+458 g H₂O) having a temperature of approx. 30° C. The temperature of the mixture rose spontaneously close to 70° C., after which the mixture was heated to a temperature of 80° C., where it was stirred for 30 minutes. The 80° C. mixture was next transferred into a vacuum evaporator, in which the mixture was dried at a temperature of 120° C. and under 30-5 mbar vacuum.

### Example 2

### Conventional Manufacture of K-Soap

100 g of fatty acid having a resin acid content of 8 weight-% was warmed to a temperature of 60° C. To the vigorously stirred prewarmed fatty acid was added slowly 477.7 g of aqueous KOH solution (19.7 g KOH+458 g H₂O) having a temperature of approx. 30° C. The temperature of the mixture rose spontaneously close to 70° C., after which the mixture was heated to a temperature of 80° C., where it was stirred for 30 minutes. The 80° C. mixture was next transferred into a vacuum evaporator, in which the mixture was dried at a temperature of 120° C. and under 30-5 mbar vacuum.

### Example 3

14.3 g of NaOH was dissolved in 26.5 g of water, to which was added 55 g of ethanol. The approx. 40° C. solution was added into 100 g of approx. 50° C. fatty acid under vigorous stirring. The temperature of the mixture rose close to 70° C., where it was stirred for 30 minutes. The 70° C. mixture was next transferred into a vacuum evaporator, in which the mixture was dried at a temperature of 90° C. and under 30-5 mbar vacuum.

### Example 4

19.7 g of KOH was dissolved in 20 g of water, to which was added 45 g of ethanol. The approx. 40° C. solution was added into 100 g of approx. 50° C. fatty acid under vigorous stirring. The temperature of the mixture rose close to 70° C., where it was stirred for 30 minutes. The 70° C. mixture was next transferred into a vacuum evaporator, in which the mixture was dried at a temperature of 90° C. and under 30-5 mbar vacuum.

### Example 5

14.2 g of NaOH was dissolved in 20 g of water, to which was added 50 g of 2-propanol. The approx. 40° C. solution was added into 98 g of approx. 50° C. fatty acid under vigorous stirring. The temperature of the mixture rose close to 70° C., where it was stirred for 30 minutes. The 70° C. mixture was next transferred into a vacuum evaporator, in which the mixture was dried at a temperature of 90° C. and under 30-5 mbar vacuum.

### Example 6

19.7 g of KOH was dissolved in 15 g of water, to which was added 35 g of 2-propanol. The approx. 40° C. solution was added into 100 g of approx. 50° C. fatty acid under vigorous stirring. The temperature of the mixture rose close to 70° C., where it was stirred for 30 minutes. The 70° C. mixture was next transferred into a vacuum evaporator, in which the mixture was dried at a temperature of 90° C. and under 30-5 mbar vacuum.

### Example 7

14.3 g of NaOH was dissolved in 20 g of water, to which was added 55 g of 1-butanol. To the approx. 40° C. solution was added 100 g of approx. 20° C. fatty acid under vigorous stirring for 10 minutes. The mixture was transferred into a vacuum evaporator, in which the mixture was dried at a temperature of 90° C. and under 30-5 mbar vacuum.

### Example 8

19.7 g of KOH was dissolved in 20 g of water, to which was added 35 g of 1-butanol. To the approx. 40° C. solution was added 100 g of approx. 20° C. fatty acid under vigorous stirring for 10 minutes. To the gel-like liquid were added with stirring 95% of water, whereby the working solution obtained was diluted to a disinfectant cleaning agent.

### Example 9

To 100 g of 20° C. fatty acid were mixed 35 g of 20° C. 1-butanol. To the resulting solution was added under vigorous stirring 39.7 g of approx. 55° C. aqueous 49.6% KOH solution, whereby the temperature of the solution rose to 65° C. Stirring was continued for 20 minutes, after which the approx. 45° C. solution was transferred into a vacuum evaporator, in which it was dried at a temperature of 90° C. and under 30-5 mbar vacuum.

### Example 10

19.7 g of KOH were dissolved in 20 g of water, to which was added 55 g of acetone. To the approx. 40° C. solution was added 100 g of approx. 20° C. fatty acid under vigorous stirring for 10 minutes. The reaction is exothermic and was carried out under continuous cooling of the reaction mixture. The evaporating solvent was condensed and returned to the reaction. To the gel-like liquid was added with stirring 95% of water, whereby the working solution obtained was diluted to a disinfectant cleaning agent.

### Example 11

8 g of resin (FOR90/Forchem Oy) was dissolved in 45 g of hot 70° C. ethanol, 19.7 g of KOH and 20 g of water. The resin was saponified by mixing the hot, approx. 70° C. mixture into a solution for approx. 30 minutes. To the resulting solution were added 92 g of mixed fatty acid distillate of vegetable oil (Deodorizer distillate), which was saponified in an analogous manner by stirring the mixture vigorously for approx. 30 minutes.

### Example 12

8 g of resin (FOR90/Forchem Oy) was dissolved in 45 g of hot 70° C. ethanol. To the solution was added 20 g of water and 19.7 g of KOH to saponify the resin. To the resulting solution was added 92 g of rapeseed oil (triglyceride, RBD Ravintoraisio Oy).

### Example 13

30 g of resin (FOR90/Forchem Oy) was dissolved and saponified in 50 g of isopropanol, to which had been added 19 g of KOH and 5 g of water. To this mixture was slowly added under vigorous stirring 70 g of rapeseed oil (triglyceride RBD Ravintoraisio Oy)

By way of example, tall oil fatty acid, solvent, water and alkali can be used in the method according to the proportions shown in Table 1.

TABLE 1
Proportions of components in the reaction mixture according to different
alternatives

| | alternative 1 | alternative 2 | alternative 3 |
|---|---|---|---|
| Component | min-max % | min-max % | min-max % |
| RH* | 40-60 | 45-55 | 45-55 |
| Solvent | 15-50 | 15-40 | 15-30 |
| Water | 3-30 | 6-20 | 8-15 |
| Alkali | 7-20 | 7-10 | 7-10 |

*RH = Fatty acid mixture comprising resin acids

### CITED REFERENCES—PATENT LITERATURE

1. FI 20120287
2. U.S. Pat. No. 2,558,543 A
3. U.S. Pat. No. 3,804,819 A
4. FI 20125509
5. FI 20136113

1. A method for manufacturing a soap from fatty and resin acids, according to which method a composition comprising fatty and resin acids is saponified with an alkali, wherein
an alkaline solution comprising water, a polar solvent and a base is formed, and
a fatty acid composition comprising resin acids is added to the alkaline solution in order to dissolve the acids contained therein into the alkaline solution, whereby the water content of the alkaline solution is kept high enough to prevent formation of fatty acid esters and to saponify the fatty and resin acids.

2. The method according to claim 1, wherein saponification is continued until at least 50 weight-%, preferably over 80 weight-%, most preferably over 95 weight-% of the resin acids and fatty acids have been saponified.

3. The method according to claim 1, wherein the fatty acid composition is added under vigorous stirring into the alkaline solution and stirring is preferably continued until a significant proportion of the fatty acids has been saponified.

4. The method according to any of claims 1 to 3, claim 1, wherein the fatty acid composition comprising resin acids is a composition comprising fatty acids of vegetable or animal origin, such as a rapeseed oil, a palm oil, an olive oil, or a composition comprising tall oil fatty acids, or a mixture thereof.

5. The method according to claim 1, wherein the polar solvent used for forming the alkaline solution is an aliphatic or aromatic alcohol or a ketone, such as an aliphatic lower alcohol or an aliphatic lower ketone, for example a C₁-C₄ alcohol, in particular methanol, ethanol, propanol or butanol, or acetone.

6. The method according to claim 1, wherein the alkali used for forming the alkaline solution is a hydroxide, such as NaOH or KOH, a metal hydride, such as Nall, or an ethylate or a methylate, such as CH₃ONa.

7. The method according to claim 1, wherein the dynamic viscosity of the mixture formed by the alkaline solution and the fatty acid composition during saponification is not more than 1000 mPa·s, in particular not more than 600 mPa·s, most suitably not more than 200 mPa·s.

8. The method according to claim 1, wherein the water content of the mixture formed by the alkaline solution and the fatty acid composition is 1 to 30 weight-%, most preferably 6 to 20 weight-%, in particular 8 to 15 weight-% of the total weight of the composition.

9. The method according to claim 1, wherein the solvent content of the mixture formed by the alkaline solution and the fatty acid composition is 15 to 50 weight-%, most preferably 15 to 40 weight-%, in particular 20 to 30 weight-% of the total weight of the composition.

10. The method according to claim 1, wherein the fatty acid composition is added into the alkaline solution, which is subjected to high-shear forces.

11. The method according to claim 1, wherein the alcohol of the alkaline solution is not essentially consumed during saponification.

12. The method according to claim 11, wherein the alcohol functions as a solvent for the saponification and is completely or partially removed, or recycled after the reaction.

13. The method according to claim 1, wherein saponification is continued until a composition is achieved having a dry matter content of at least 40 weight-%, most preferably between 50 and 60 weight-%, of which dry matter the fatty acid soap constitutes at least 20 weight-%, more preferably at least more than 50 weight-%, in particular about 80 to 99 weight-%.

14. The method according to claim 1, wherein at least 80 weight-%, more preferably at least 90 weight-% of the acids are saponified.

15. The method according to claim 1, wherein a composition is recovered which is a composition obtained from the saponification of fatty and resin acids.

16. The method according to claim 1, wherein a composition is recovered which comprises 0.5 to 95 weight-%, in particular about 1 to 35 weight-% of saponified resin acids.

17. The method according to claim 1, wherein the soap is manufactured from fatty and resin acids of tall oil, wherein the tall oil composition comprising fatty and resin acids is saponified with an alkali.

18. The method according to claim 1, wherein the composition is dried to a dry matter content of 95 to 100 weight-%.

19. A composition comprising fatty and resin acid soap, having a dry matter content of at least 40 weight-% and comprising about 15 to 50% of a polar solvent based on the total weight of the composition.

20. The composition according to claim 19, wherein its dry matter content is 60 to 70 weight-% and it comprises 10 to 20 weight-% of a polar solvent.

21. The composition according to claim 19, wherein it has a dry matter content of 95 to 100 weight-%.

22. The composition according to claim 19, wherein the polar solvent is an aliphatic or aromatic alcohol or a ketone, such as an aliphatic lower alcohol or an aliphatic lower ketone, for example a C₁-C₄ alcohol, in particular methanol, ethanol, propanol or butanol, or acetone.

23. The composition according to claim 19, wherein the composition comprises 0.5 to 95 weight-%, in particular about 1 to 35 weight-% of saponified resin acids.

24. The composition according to claim 19, wherein it is obtained by a method according to any of claims 1 to 18.

25. Use of a composition manufactured according to claim 1 as a disinfectant or antiseptic agent or as a concentrate thereof.

26. The use according claim 25, wherein the composition being used comprises ethanol or a corresponding biocompatible substance as a solvent.
